(19) United States
(12) Patent Application Publication
(10) Pub. No.: US 2019/0150509 A1
(43) Pub. Date: May 23, 2019

(54) BATTERY ASSEMBLY AND ELECTRONIC CIGARETTE THEREOF

(71) Applicant: Changzhou Patent Electronic Technology Co., LTD, Changzhou (CN)

(72) Inventors: Weihua QIU, Changzhou (CN); Defu ZHANG, Changzhou (CN)

(21) Appl. No.: 16/190,963

(22) Filed: Nov. 14, 2018

(30) Foreign Application Priority Data
Nov. 17, 2017 (CN) 201721548719.4

(51) Int. Cl. A24F 47/00; H01M 2/10

(52) U.S. Cl. CPC A24F 47/008; H01M 2220/30; H01M 2/1066

(57) ABSTRACT

A battery assembly and an electronic cigarette are provided. The battery assembly includes a housing, a first cover provided with a first mounting column, and an electronic switch received in the first cover. The first cover defines a first mounting slot corresponding to the electronic switch. The first cover is mounted on the housing by the cooperation of the first mounting column and the first mounting slot, pressing the outside wall of the first cover causes the first mounting column to press the electronic switch and turn on the electronic switch. The structure of the battery assembly is simple, the processing operation becomes easy, and the manufacturing cost is low.

### CROSS-REFERENCE TO RELATED APPLICATIONS

The application claims benefit of Chinese Patent Application Serial Number CN201721548719.4, filed on Nov. 11, 2017, entitled “battery assembly and electronic cigarette thereof,” which is incorporated herein by reference in its entirety.

### FIELD OF TECHNOLOGY

The present disclosure relates to the field of simulated smoking technology, and more particularly to a battery assembly and an electronic cigarette using the same.

### BACKGROUND

The electronic cigarette includes a battery assembly and an atomizer mounted on the battery assembly. The atomizer electrical drove by the battery assembly is configured for heating the aerosol-forming substrate to produce smoke for user.

A button is generally provided on the battery assembly for user to operate. The button needs to be provided with a screw column, so that the button can be mounted on the main body of the battery assembly, and a button column is also required to enable the button to cooperate with the electronic switch within the main body of the battery assembly. It can be seen that there are many parts of the button, which makes the processing more complicated and costly.

### SUMMARY

The present disclosure provides a battery assembly and an electronic cigarette thereof. The battery assembly has a simple structure, is easy to process, and has low production cost.

An battery assembly includes a housing, a first cover provided with a first mounting column, and an electronic switch received in the first cover, the first cover defines a first mounting slot corresponding to the electronic switch, the first cover is mounted on the housing by the cooperation of the first mounting column and the first mounting slot, pressing the outside wall of the first cover causes the first mounting column to press the electronic switch and turn on the electronic switch.

In one embodiment, the first mounting column includes a mounting portion and a button integrally formed with the mounting portion, the button protruded from one end of the mounting portion is close to the electronic switch, the button portion presses the electronic switch when the cover is pressed.

In one embodiment, the button is made of elastic material, and/or electronic switch provided with an elastic member, after the external force applied to the first cover is released, the elastic member restores to its initial state by the springback force, which causes the button to be separated from the electronic switch.

In one embodiment, the mounting portion is provided with a through hole disposed along the axial direction of the first mounting column, the through hole is a waist hole, the opposite side walls of the first mounting slot are respectively provided with a first limiting hole corresponding to the through hole, the battery assembly further includes a first limiting column, the opposite ends of the first limiting column extend through the through hole and are respectively mounted in the first limiting holes.

In one embodiment, the first cover further provides with a second mounting column, the housing further defines a second mounting slot, the second mounting column is inserted in the second mounting slot, and cooperates with the first mounting column and the first mounting groove to mount the first cover on the housing.

In one embodiment, the second mounting column defines a fixing hole, the opposite sidewalls of the second mounting slot are respectively provided with a second limiting hole corresponding to the fixing hole, the battery assembly further includes a second limiting column, the second limiting column is disposed in the fixing hole, two ends of the second limiting post are extending through the fixing hole and are respectively mounted in the limiting holes.

In one embodiment, one end of the housing defines a groove close to the first mounting column, the first cover is provided with a blocking piece located above the first mounting column and protruded from the first cover toward the housing, the blocking piece is inserted into the groove, a gap is formed between the blocking piece and the bottom of the groove.

In one embodiment, the housing defines an atomizer mounting hole, an electrode contact is located in the atomizer mounting hole, when an atomizer mounted in the atomizer mounting hole, the atomizer is electrically connected to the electrode contact.

In one embodiment, the end surface area of the electronic switch that matches the button is smaller the end surface area of the button.

An electronic cigarette, includes an atomizer, and a battery assembly electrically connected to the atomizer, the battery assembly includes a housing, a first cover provided with a first mounting column, and an electronic switch received in the first cover, the first cover defines a first mounting slot corresponding to the electronic switch, the first cover is mounted on the housing by the cooperation of the first mounting column and the first mounting slot, pressing the outside wall of the first cover causes the first mounting column to press the electronic switch and turn on the electronic switch.

In one embodiment, the first mounting column includes a mounting portion and a button integrally formed with the mounting portion, the button protruded from one end of the mounting portion is close to the electronic switch, the button portion presses the electronic switch when the cover is pressed.

In one embodiment, the button is made of an elastic material, and/or electronic switch provided with an elastic member, after the external force applied to the first cover is released, the elastic member restores to its initial state by the springback force, which causes the button to be separated from the electronic switch.

In one embodiment, the mounting portion is provided with a through hole disposed along the axial direction of the first mounting column, the through hole is a waist hole, the opposite side walls of the first mounting slot are respectively provided with a first limiting hole corresponding to the through hole, the battery assembly further includes a first limiting column, the opposite ends of the first limiting column extend through the through hole and are respectively mounted in the first limiting holes.

In one embodiment, the first cover further provides with a second mounting column, the housing further defines a second mounting slot, the second mounting column is inserted in the second mounting slot, and cooperates with the first mounting column and the first mounting groove to mount the first cover on the housing.

In one embodiment, the second mounting column defines a fixing hole, the opposite sidewalls of the second mounting slot are respectively provided with a second limiting hole corresponding to the fixing hole, the battery assembly further includes a second limiting column, the second limiting column is disposed in the fixing hole, two ends of the second limiting post are extending through the fixing hole and are respectively mounted in the limiting holes.

In one embodiment, one end of the housing defines a groove close to the first mounting column, the first cover is provided with a blocking piece the blocking piece is located above the first mounting column and protruded from the first cover toward the housing, the blocking piece is inserted into the groove, a gap is formed between the blocking piece and the bottom of the groove.

In one embodiment, the housing defines an atomizer mounting hole, an electrode contact is located in the atomizer mounting hole, when an atomizer mounted in the atomizer mounting hole, the atomizer is electrically connected to the electrode contact.

In one embodiment, the end surface area of the electronic switch that matches the button is smaller the end surface area of the button.

The beneficial effects of the utility model are:

The first mounting column disposed on the first cover is for mounting the first cover, the first mounting column also functions as a button column for pressing the electronic switch. Since the first cover functions as a button, the additional button is omitted, so that the structure is simple, the processing operation becomes easy, and the manufacturing cost is low.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a cross-sectional view of a battery assembly according to an embodiment of the present disclosure;

FIG. 2 is an exploded view of the battery assembly of FIG. 1 when the cover of the battery assembly is separated from the housing;

FIG. 3 is another exploded view of the battery assembly of FIG. 1 when the cover of the battery assembly is separated from the housing;

FIG. 4 is an assembled view of the battery assembly in the embodiment of the present disclosure.

The following table list various components and reference numerals thereof.

DETAILED DESCRIPTION OF PREFERRED EMBODIMENTS

| | |
|---|---|
| Housing 1 | battery cell 2 |
| First cover 3 | Circuit board 4 |
| Electronic switch 5 | Second cover 6 |
| First mounting column 7 | First mounting slot 8 |
| Button 9 | Through hole 10 |
| First limiting hole 11 | First limiting column 12 |
| Second mounting column 13 | Second mounting slot 14 |
| Fixing hole 15 | Second limiting column 16 |
| groove17 | Blocking piece18 |
| Atomizer mounting hole19 | electrode contact 20 |
| Mounting portion 21 | |

The specific embodiments of the present disclosure will be described in detail below with reference to the accompanying drawings. It should be understood that the specific embodiments described herein are only used to illustrate and explain the present disclosure and are not intended to limit the present disclosure.

An embodiment of the present disclosure discloses an electronic cigarette, the electronic cigarette includes a battery assembly.

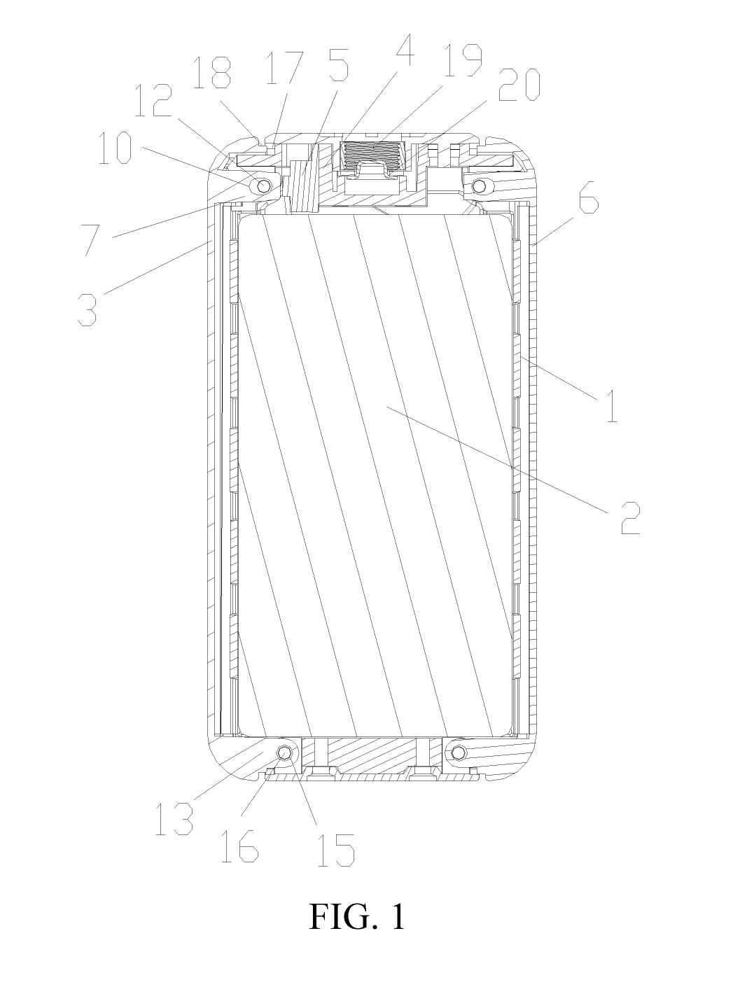

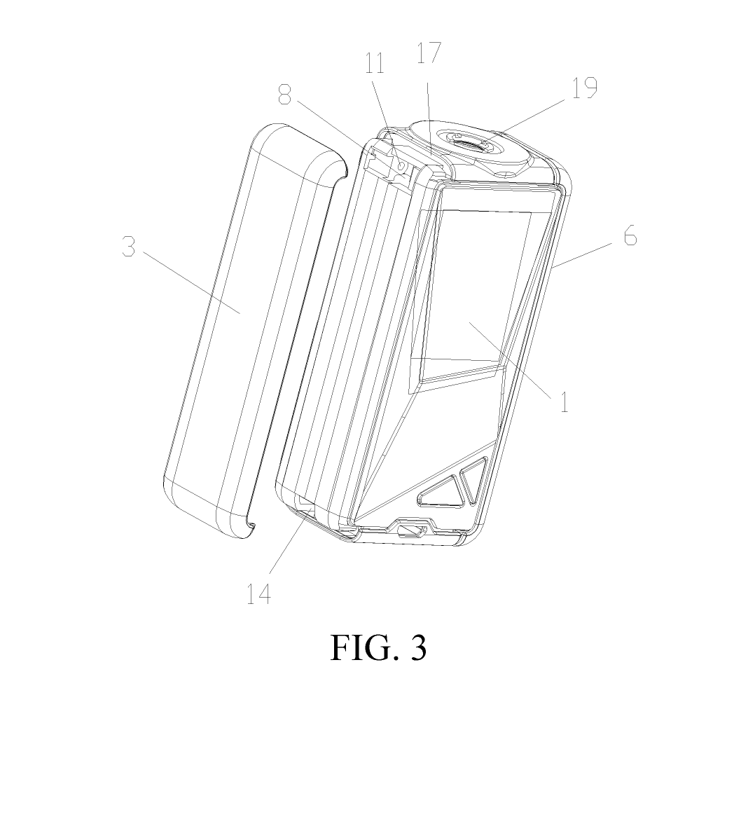

Referring to FIG. 1 and FIG. 3, the battery assembly includes a housing 1, a battery cell 2, and a first cover 3. The battery cell 2 is located in the housing 1, and the first cover 3 is disposed on the housing 1. A circuit board 4 and an electronic switch 5 are received in the housing 1. The circuit board 4 is electrically connected to the electronic switch 5, and the circuit board 4 is also electrically connected to the battery cell 2. A first mounting slot 8 is defined in the housing 1 corresponding to the electronic switch 5, and the electronic switch 5 is at least partially protruded from the first mounting slot 8. The first cover 3 is provided with a first mounting column 7 corresponding to the first mounting slot 8. The first mounting column 7 is at least partially received in the first mounting slot 8. The first cover 3 is mounted on the housing 1 by the cooperation of the first mounting column 7 and the first mounting slot 8. Pressing the outside of the first cover 3 allows the first mounting column 7 to press the electronic switch 5, thereby turning on the electronic switch 5.

Specifically, the battery cell 2 is supported on the bottom of the housing 1, and the first cover 3 is disposed on one side of the housing 1. In this embodiment, the side of the housing 1 for mounting the first cover 3 is closed, and the user cannot install or remove the battery cell 2 by removing the first cover 3 at this side. It can be understood that, in other embodiments not shown, the side of the housing 1 for mounting the first cover 3 has an opening. Thus, after opening the first cover 3, the battery cell 2 can be mounted in the housing 1 through the opening or the battery cell 2 can be detached from the housing 1. The circuit board 4 and the electronic switch 5 are mounted in a gap between the upper end of the battery cell 2 and the housing 1. The electronic switch 5 corresponding to the first mounting slot 8 is close to the first cover 3, therefore the first mounting slot 8 is directly aligned with the electronic switch 5.

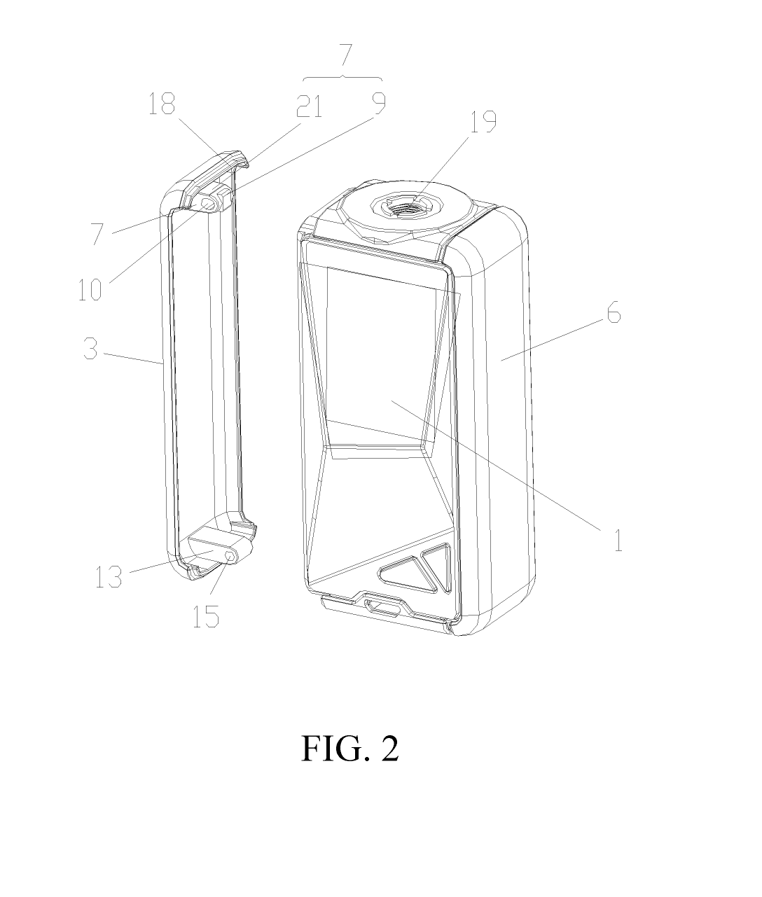

As shown in FIG. 2, the first cover 3 is designed to fully cover one side of the housing 1. The first mounting column 7 includes a mounting portion 21 and a button 9 integrally formed with the mounting portion 21. The button 9 protruded from one end of the mounting portion 21 is close to the electronic switch 5. The end surface of the button 9 has a shape that matches the end surface of the electronic switch 5. In this embodiment, the end surface of the electronic switch 5 and the end surface of the button 9 are both set to a flat plane, and the end surface area of the button 9 is larger than the end surface area of the electronic switch 5, such that the contact between the button 9 and the electronic switch 5 is better, and the occurrence of poor contact is reduced. It can be understood that, in other embodiments not shown, the mounting portion 21 and a button 9 are separately formed.

In one embodiment, the button 9 is made of elastic material, such as rubber or silicone.

When the outside wall of the first cover 3 is pressed, the button 9 comes into contact with the electronic switch 5 and is elastically deformed. After the external force applied to the first cover 3 is released, the button 9 is restored to its initial state and separated from the electronic switch 5.

In another embodiment, the electronic switch 5 is provided with an elastic member (not shown) corresponding to the button 9, such as a spring, a clips and so on. When the outside wall of the first cover 3 is pressed to make the button 9 touches the electronic switch 5, the elastic member is elastically deformed by the pressing of the button 9. After the external force applied to the first cover 3 is released, the elastic member restores to its initial state by the springback force, which causes the button 9 to be separated from the electronic switch 5.

In still another embodiment, the button 9 is made of an elastic material and the electronic switch 5 is provided with an elastic member. It can be understood that, for any of the above embodiments, when the button 9 is separated from the electronic switch 5, the contact pressure caused by the button 9 disappears, then the electronic switch 5 is turned off.

As shown in FIGS. 1, 2, and 3, the mounting portion 21 is provided with a through hole 10 disposed along the axial direction of the first mounting column 7. The opposite side walls of the first mounting slot 8 are respectively provided with a first limiting hole 11 corresponding to the through hole 10. The battery assembly further includes a first limiting column 12, one end of the first limiting column 12 is mounted in one of the first limiting holes 11, and the opposite end of the first limiting column 12 extends through the through hole 10 and then is mounted on the other first limiting hole 11. In one aspect, the first limiting column 12 cooperates with the through hole 10, such that the first cover 3 is disposed on the housing 1 to prevent the first cover 3 from falling off the housing 1. On the other hand, the first limiting column 12 cooperates with the through hole 10, the first mounting column 7 can move back and forth relative to the first limiting column 12, so that the first cover 3 can be pressed to realize the switching function. In the embodiment, the through hole 10 is a waist hole.

The first cover 3 is further provided with a second mounting column 13, and the housing 1 further provided with a second mounting slot 14. The second mounting column 13 is inserted in the second mounting slot 14, and cooperates with the first mounting column 7 and the first mounting slot 8 to allow the first cover 3 to be provided on the housing 1. The first mounting column 7 and the second mounting column 13 are respectively disposed at the upper and lower ends of the first cover 3 to increase the stability of the first cover 3 mounted on the housing 1.

The second mounting column 13 defines a fixing hole 15, the opposite sidewalls of the second mounting slot 14 are respectively provided with a second limiting hole (not shown) corresponding to the fixing hole 15. The battery assembly further includes a second limiting column 16, one end of the second limiting column 16 is mounted in one of the second limiting holes, and the other end of the second limiting column 16 is extending through the fixing hole 15 and then mounted on the another limiting hole. Similarly, the second limiting column 16 is configured for limiting the first cover 3 to prevent the first cover 3 from falling off the housing 1. In addition, since the first cover 3 at one end of the second mounting column 13 does not need to be pressed, the second limiting column 16 only has the function of mounting the first cover 3, therefore the fixing hole 15 is a standard circular hole, the second mounting column 13 is immovably fixed in the second mounting slot 14.

A groove 17 is provided at one end of the housing 1 near the first mounting column 7, the first cover 3 is provided with a blocking piece 18, the blocking piece 18 is located above the first mounting column 7 and protruded from the first cover 3 toward the housing 1. The blocking piece 18 is inserted into the groove 17, a gap is formed between the blocking piece 18 and the bottom of the groove 17. The gap between the blocking piece 18 and the bottom of the groove 17 provides a displacement space for the first cover 3 when the first cover 3 is pressed, making pressing operation less laborious and more convenient. The engagement of the blocking piece 18 with the groove 17 also provides a guiding effect on the movement of the first cover 3.

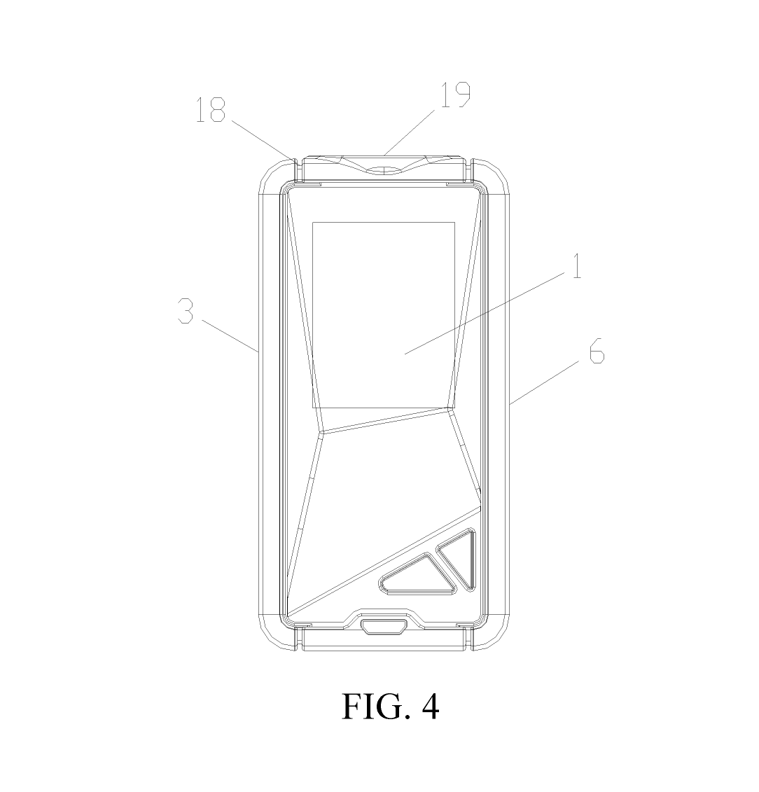

As shown in FIGS. 1 and 4, a second cover 6 opposite to the first cover 3 is disposed on one side of the housing 1. Specifically, the first cover 3 and the second cover 6 are symmetrically disposed on the housing 1. When the battery assembly is assembled or disassembled, both sides can be simultaneously operated, which makes the installation or disassembly more convenient. It can be understood that the first cover 3 and the second cover 6 can be designed to have the same structure. Correspondingly, the corresponding sides of the housing 1 are designed as mirror-symmetrical structures, thereby the adaptability of the first cover 3 during installation is increased.

As shown in FIG. 1 and FIG. 4, the housing 1 is provided with an atomizer mounting hole 19, and an electrode contact 20 is located in the atomizer mounting hole 19, and the electrode contact 20 and the circuit board 4 are electrically connected. The atomizer mounting hole 19 is used for connecting the battery assembly to the atomizer of the electronic cigarette. In the embodiment, the atomizer mounting hole 19 is configured as a threaded hole, and the atomizer an the battery assembly are connected by means of a screw connection.

In summary, the first mounting column 7 disposed on the first cover 3 is for mounting the first cover 3, the first mounting column 7 also functions as a button column for pressing the electronic switch 5. Since the first cover 3 is used as a button, the additional button is omitted, so that the structure is simple, the processing operation becomes easy, and the manufacturing cost is low.

The above-mentioned embodiments merely represent several implementations of the present application, and the descriptions thereof are more specific and detailed, but they shall not be understood as a limitation on the scope of the present application. It should be noted that, for those of ordinary skill in the art, variations and improvements may still be made without departing from the concept of the present application, and all of which shall fall into the protection scope of the present application. Therefore, the scope of protection of the present application shall be subject to the appended claims.

What is claimed is:

1. An battery assembly comprising:
a housing,
a first cover provided with a first mounting column, and
an electronic switch received in the first cover, the first cover defines a first mounting slot corresponding to the electronic switch, the first cover is mounted on the housing by the cooperation of the first mounting column and the first mounting slot, pressing the outside wall of the first cover causes the first mounting column to press the electronic switch and turn on the electronic switch.

2. The battery assembly according to the claim 1, wherein the first mounting column comprises a mounting portion and a button integrally formed with the mounting portion, the button protruded from one end of the mounting portion is close to the electronic switch, the button portion presses the electronic switch when the cover is pressed.

3. The battery assembly according to the claim 2, wherein the button is made of elastic material, and/or electronic switch provided with an elastic member, after the external force applied to the first cover is released, the elastic member restores to its initial state by the springback force, which causes the button to be separated from the electronic switch.

4. The battery assembly according to the claim 2, wherein the mounting portion is provided with a through hole disposed along the axial direction of the first mounting column, the through hole is a waist hole, the opposite side walls of the first mounting slot are respectively provided with a first limiting hole corresponding to the through hole, the battery assembly further comprises a first limiting column, the opposite ends of the first limiting column extend through the through hole and are respectively mounted in the first limiting holes.

5. The battery assembly according to the claim 1, wherein the first cover further provides with a second mounting column, the housing further defines a second mounting slot, the second mounting column is inserted in the second mounting slot, and cooperates with the first mounting column and the first mounting groove to mount the first cover on the housing.

6. The battery assembly according to the claim 5, wherein the second mounting column defines a fixing hole, the opposite sidewalls of the second mounting slot are respectively provided with a second limiting hole corresponding to the fixing hole, the battery assembly further comprises a second limiting column, the second limiting column is disposed in the fixing hole, two ends of the second limiting post are extending through the fixing hole and are respectively mounted in the limiting holes.

7. The battery assembly according to the claim 1, wherein one end of the housing defines a groove close to the first mounting column, the first cover is provided with a blocking piece the blocking piece is located above the first mounting column and protruded from the first cover toward the housing, the blocking piece is inserted into the groove, a gap is formed between the blocking piece and the bottom of the groove.

8. The battery assembly according to the claim 1, wherein the housing defines an atomizer mounting hole, an electrode contact is located in the atomizer mounting hole, when an atomizer mounted in the atomizer mounting hole, the atomizer is electrically connected to the electrode contact.

9. The battery assembly according to the claim 2, wherein the end surface area of the electronic switch that matches the button is smaller the end surface area of the button.

10. An electronic cigarette, comprising:
an atomizer, and
a battery assembly electrically connected to the atomizer, the battery assembly comprises a housing, a first cover provided with a first mounting column, and an electronic switch received in the first cover, the first cover defines a first mounting slot corresponding to the electronic switch, the first cover is mounted on the housing by the cooperation of the first mounting column and the first mounting slot, pressing the outside wall of the first cover causes the first mounting column to press the electronic switch and turn on the electronic switch.

11. The electronic cigarette according to the claim 10, wherein the first mounting column comprises a mounting portion and a button integrally formed with the mounting portion, the button protruded from one end of the mounting portion is close to the electronic switch, the button portion presses the electronic switch when the cover is pressed.

12. The electronic cigarette according to the claim 11, wherein the button is made of elastic material, and/or electronic switch provided with an elastic member, after the external force applied to the first cover is released, the elastic member restores to its initial state by the springback force, which causes the button to be separated from the electronic switch.

13. The electronic cigarette according to the claim 11, wherein the mounting portion is provided with a through hole disposed along the axial direction of the first mounting column, the through hole is a waist hole, the opposite side walls of the first mounting slot are respectively provided with a first limiting hole corresponding to the through hole, the battery assembly further comprises a first limiting column, the opposite ends of the first limiting column extend through the through hole and are respectively mounted in the first limiting holes.

14. The electronic cigarette according to the claim 10, wherein the first cover further provides with a second mounting column, the housing further defines a second mounting slot, the second mounting column is inserted in the second mounting slot, and cooperates with the first mounting column and the first mounting groove to mount the first cover on the housing.

15. The electronic cigarette according to the claim 14, wherein the second mounting column defines a fixing hole, the opposite sidewalls of the second mounting slot are respectively provided with a second limiting hole corresponding to the fixing hole, the battery assembly further comprises a second limiting column, the second limiting column is disposed in the fixing hole, two ends of the second limiting post are extending through the fixing hole and are respectively mounted in the limiting holes.

16. The electronic cigarette according to the claim 10, wherein one end of the housing defines a groove close to the first mounting column, the first cover is provided with a blocking piece the blocking piece is located above the first mounting column and protruded from the first cover toward the housing, the blocking piece is inserted into the groove, a gap is formed between the blocking piece and the bottom of the groove.

17. The electronic cigarette according to the claim 10, wherein the housing defines an atomizer mounting hole, an electrode contact is located in the atomizer mounting hole, when an atomizer mounted in the atomizer mounting hole, the atomizer is electrically connected to the electrode contact.

18. The electronic cigarette according to the claim 11, wherein the end surface area of the electronic switch that matches the button is smaller the end surface area of the button.
